(19) United States
(12) Patent Application Publication
(10) Pub. No.: US 2004/0193503 A1
(43) Pub. Date: Sep. 30, 2004

(54) Interactive sales performance management system

(76) Inventor: Jeff Scott Eder, Mill Creek, WA (US)

Correspondence Address: JEFF EDER, 19108 30TH DRIVE SE, MILL CREEK, WA, 98012, US

(21) Appl. No.: 10/746,673

(22) Filed: Dec. 24, 2003

Related U.S. Application Data
(62) Division of application No. 09/678,019, filed on Oct. 4, 2000, now abandoned.

(51) Int. Cl. G06F 17/60

(52) U.S. Cl. 705/26

(57) ABSTRACT

A method of and system for improving the financial performance and operational effectiveness of an interactive sales process. Interactive sales processes include on-line interactive sales from e-commerce web sites, sales from on-line exchanges, sales completed by telemarketing centers and combinations thereof.

### DIVISIONAL AND CROSS REFERENCE TO RELATED PATENT AND APPLICATIONS

This application is a divisional of application Ser. No. 09/678,019, filed Oct. 4, 2000. The subject matter of this application is also related to the subject matter of U.S. Pat. No. 5,615,109 for “Method of and System for Generating Feasible, Profit Maximizing Requisition Sets”, by Jeff S. Eder and U.S. patent application Ser. No. 09/940,450 filed Aug. 29, 2001 the disclosures of which are incorporated herein by reference.

### BACKGROUND OF THE INVENTION

This invention relates to a method of and system for improving the financial performance and operational effectiveness of an interactive sales process. Interactive sales processes include on-line interactive sales from e-commerce web sites, sales from on-line exchanges, sales completed by telemarketing centers and combinations thereof.

### SUMMARY OF THE INVENTION

It is a general object of the present invention to provide a novel and useful system for improving the financial performance and operational effectiveness of an interactive sales process. Performance improvements are enabled by:

1) Systematically analyzing customer purchase patterns in a novel way that allows the “interactive sales” company to identify the products and services that drive purchase activity;

2) Marrying the insight regarding “sales activity drivers” with an improved understanding of customer value as required to develop promotional offerings that add value to the company;

3) Supplementing the customer value information with information regarding supplier value to ensure that any promotions favor the most valuable suppliers; and/or

4) Integrating supply chain information with the analysis of promotional offerings and “sales activity drivers” to ensure that the offers that are promoted can be fulfilled in a timely manner and that they take full advantage of volume discounts.

The system works in concert with performance management systems for an enterprise or organization to give users the ability to track the changes in the value of the customer and supplier bases over time. As such, the systems work together to provide the user with a long term measure of the effectiveness of customer acquisition and retention programs.

### BRIEF DESCRIPTION OF DRAWINGS

These and other objects, features and advantages of the present invention will be more readily apparent from the following description of one embodiment of the invention in which:

FIG. 1 is a block diagram showing the major processing steps of the present invention;

FIG. 2 is a diagram showing the files or tables in the application database of the present invention that are utilized for data storage and retrieval during the processing that improves the performance of an interactive sales process;

FIG. 3 is a block diagram of an implementation of the present invention;

FIG. 4 is a diagram showing the data windows that are used for receiving information from and transmitting information to the user (20) during system processing;

FIG. 5A, FIG. 5B and FIG. 5C are block diagrams showing the sequence of steps in the present invention used for specifying system settings and for initializing and operating the data bots that extract, aggregate, store and manipulate information utilized in system processing from: user input, a web transaction database, an enterprise performance management system database, an organization performance management system database, a supply chain system database, a customer relationship management system database and the internet;

FIG. 6 is a block diagram showing the sequence of steps in the present invention used for determining the price ranges and preferred products by customer type; and

FIG. 7 is a block diagram showing the sequence of steps in the present invention used in identifying customers, and displaying the promotional items and prices to the user and customer.

### DETAILED DESCRIPTION OF AN EMBODIMENT

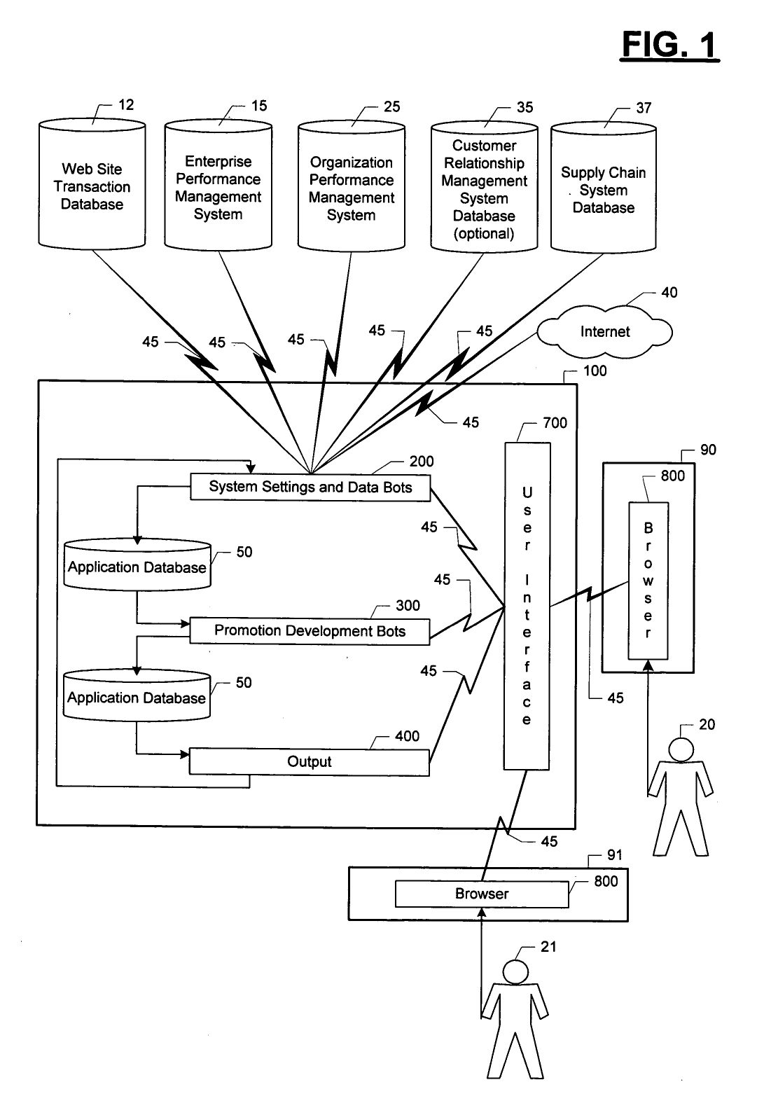

FIG. 1 provides an overview of the processing completed by the innovative system for interactive sales performance management. In accordance with the present invention, an automated method of and system (100) for activity analysis and promotion coordination is provided. Processing starts in this system (100) with the specification of system settings and the initialization and activation of software data “bots” (200) that extract, aggregate, manipulate and store the data and user (20) input required for completing system processing. This information is extracted via a network (45) from: a sales transaction database (12), an enterprise performance management system database (15), an organization performance management system database (25), a customer relationship management system database (35), a supply chain system database (37) and the Internet (40). One or more of these database types These information extractions and aggregations may be influenced by a user (20) through interaction with a user-interface portion of the application software (700) that mediates the display, transmission and receipt of all information to and from a browser (800) such as Netscape Navigator or Microsoft Internet Explorer in an access device (90) such as a phone or personal computer that the user (20) operates. While only one database of each type (12, 15, 25, 35 and 37) is shown in FIG. 1, it is to be understood that the system (100) can extract data from multiple databases of each type via the network (45). In one embodiment, the customer (21) communicates with the interactive sales processing system using an access device (91) such as a phone or personal computer that contains a browser (800) such as Netscape Navigator or Microsoft Internet Explorer. It should also be understood that it is possible to complete a bulk extraction of data from each database (12, 15, 25, 35 and 37) via the network (45) using data extraction applications such before initializing the data bots. The data extracted in bulk could be stored in a single datamart or data warehouse where the data bots could operate on the aggregated data.

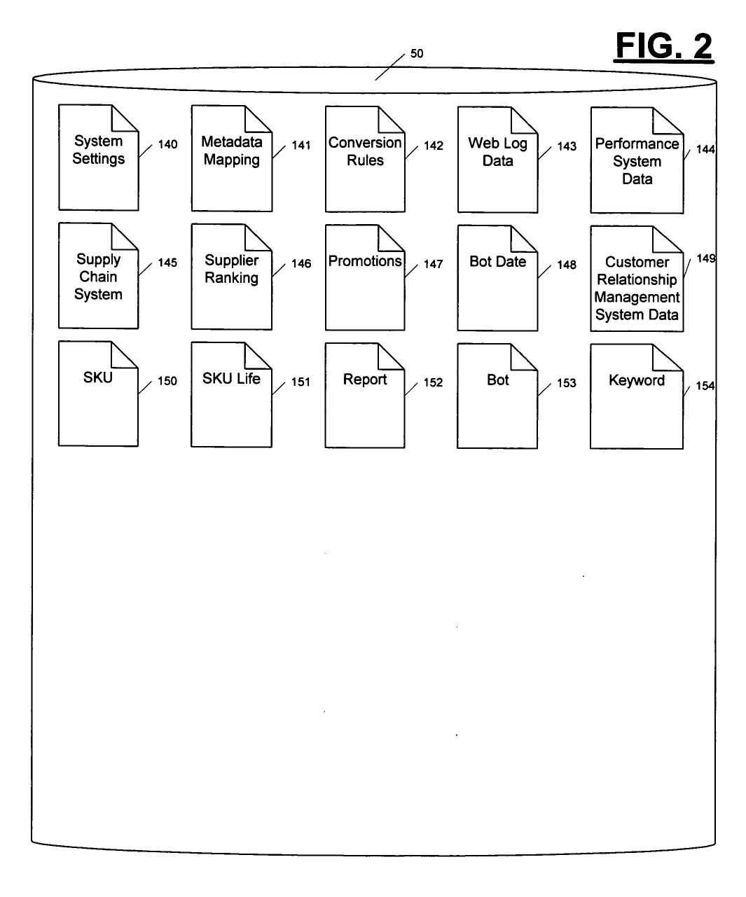

All extracted information is stored in a file or table (hereinafter, table) within an application database (50) as shown in FIG. 2. The application database (50) contains tables for storing user input, extracted information and system calculations including a: system settings table (140), a metadata mapping table (141), a conversion rules table (142), a web log data table (143), a performance system table (144), a supply chain system table (145), a supplier ranking table (146), a promotions table (147), a bot date table (148), a customer relationship management system table (149), a sku table (150), a sku life table (151), a report table (152), a bot table (153) and a cluster id table (154). The application database (50) can optionally exist as a datamart, data warehouse, departmental warehouse or some combination thereof. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in one embodiment all required information is obtained from the specified data sources (12, 15, 25, 35, 37 and 40).

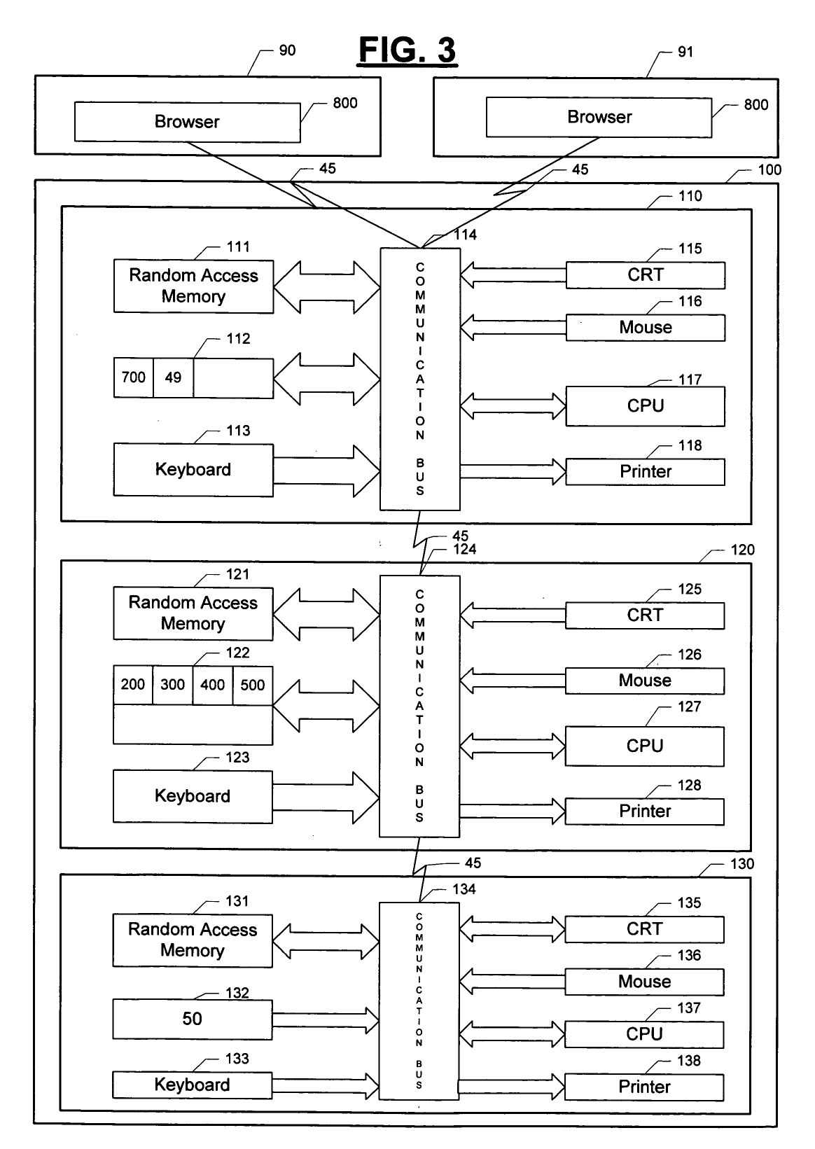

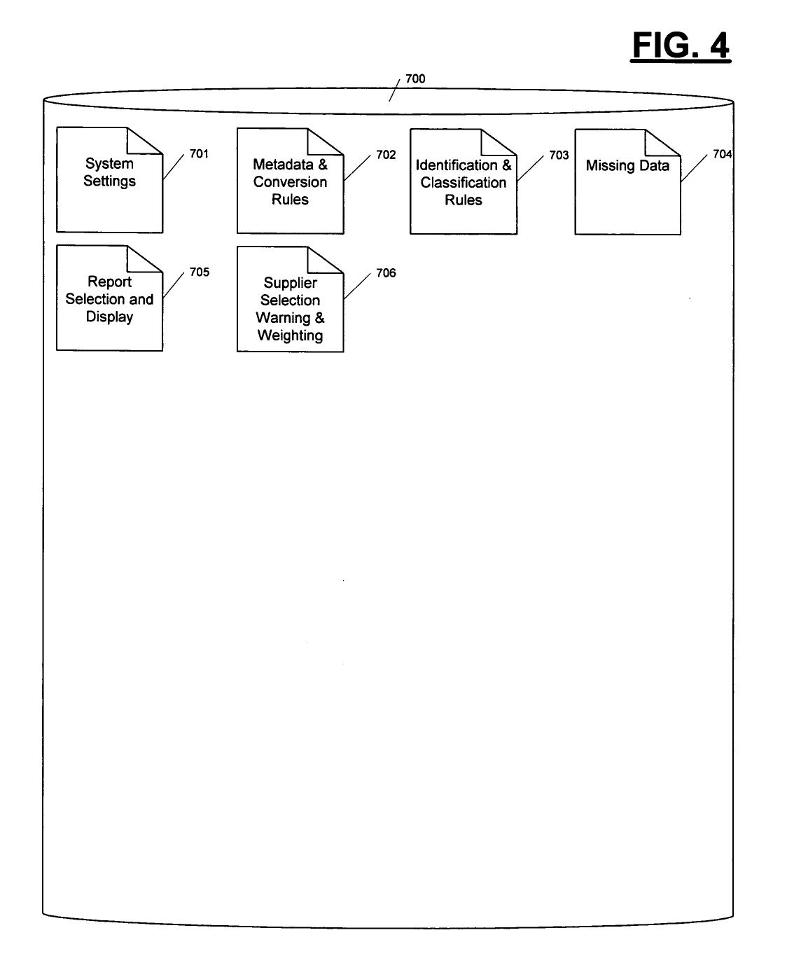

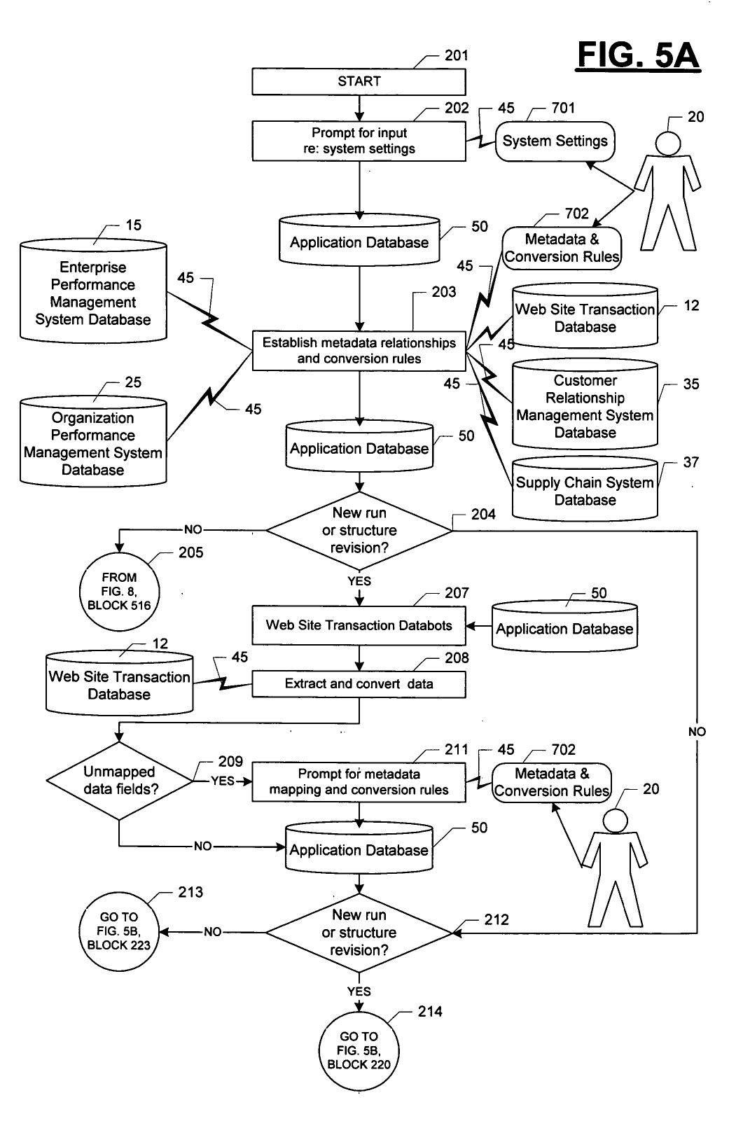

As shown in FIG. 3, one embodiment of the present invention is a computer system (100) illustratively comprised of a user-interface personal computer (110) connected to an application server personal computer (120) via a network (45). The application server personal computer (120) is in turn connected via the network (45) to a database-server personal computer (130). The user interface personal computer (110) is also connected via the network (45) to an internet browser appliance (90) that contains browser software (800) such as Microsoft Internet Explorer or Netscape Navigator.

The database-server personal computer (130) has a read/write random access memory (131), a hard drive (132) for storage of the application database (50), a keyboard (133), a communication bus (134), a CRT display (135), a mouse (136), a CPU (137) and a printer (138).

The application-server personal computer (120) has a read/write random access memory (121), a hard drive (122) for storage of the non-user interface portion of the application software (200, 300, 400 and 500) of the present invention, a keyboard (123), a communication bus (124), a CRT display (125), a mouse (126), a CPU (127) and a printer (128). While only one client personal computer is shown in FIG. 3, it is to be understood that the application-server personal computer (120) can be networked to fifty or more client personal computers (110) via the network (45). The application-server personal computer (120) can also be networked to fifty or more server personal computers (130) via the network (45). It is to be understood that the diagram of FIG. 3 is merely illustrative of one embodiment of the present invention.

The user-interface personal computer (110) has a read/write random access memory (111), a hard drive (112) for storage of a client data-base (49) and the user-interface portion of the application software (700), a keyboard (113), a communication bus (114), a CRT display (115), a mouse (116), a CPU (117) and a printer (118).

The application software (200, 300, 400 and 700) controls the performance of the central processing unit (127) as it completes the calculations required to complete the detailed activity analysis and promotion coordination. In the embodiment illustrated herein, the application software program (200, 300, 400 and 700) is written in a combination of C++ and Visual Basic®. The application software (200, 300, 400 and 700) can use Structured Query Language (SQL) for extracting data from the databases and the internet (12, 15, 25, 35, 37 and 40). The user (20) can optionally interact with the user-interface portion of the application software (700) using the browser software (800) in the browser appliance (90) to provide information to the application software (200, 300, 400 and 700) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120 and 130) shown in FIG. 3 illustratively are IBM PCs or clones or any of the more powerful computers or workstations that are widely available. Typical memory configurations for client personal computers (110) used with the present invention should include at least 512 megabytes of semiconductor random access memory (111) and at least a 100 gigabyte hard drive (112). Typical memory configurations for the application-server personal computer (120) used with the present invention should include at least 2056 megabytes of semiconductor random access memory (121) and at least a 250 gigabyte hard drive (122). Typical memory configurations for the database-server personal computer (130) used with the present invention should include at least 4112 megabytes of semiconductor random access memory (135) and at least a 500 gigabyte hard drive (131).

Using the system described above, customer activity is analyzed, targeted promotions are developed and checked against supply chain availability and each element of value within the enterprise is analyzed using information supplied by one of the performance management systems (15 or 25)

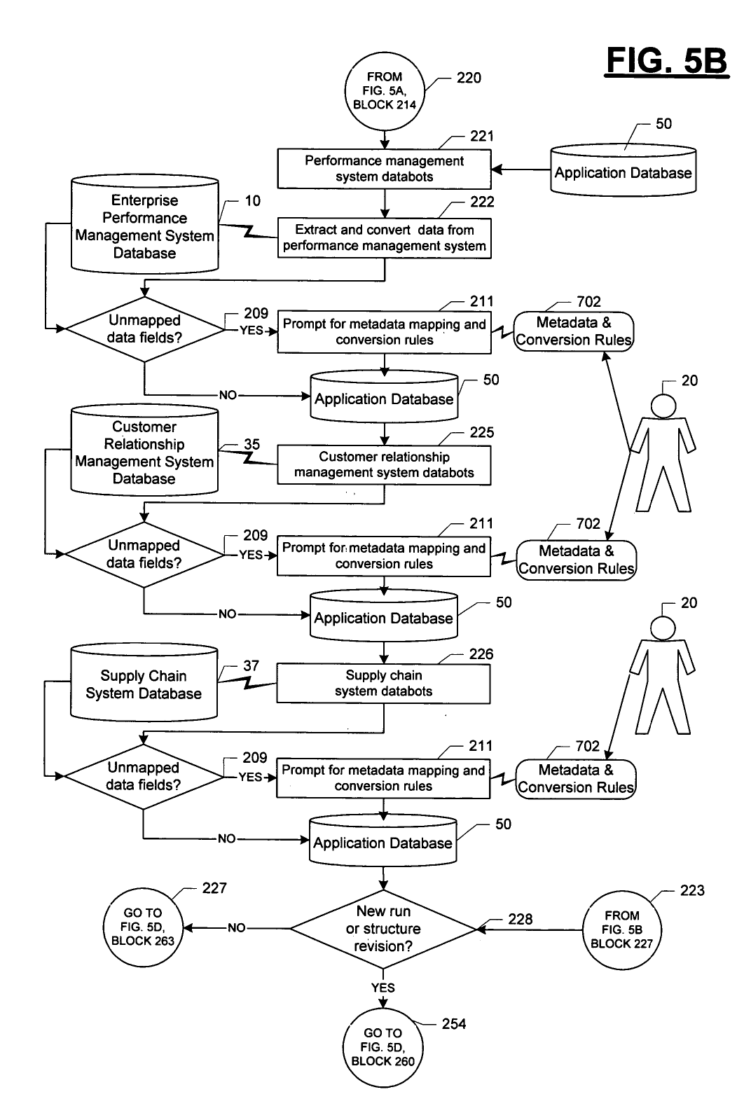

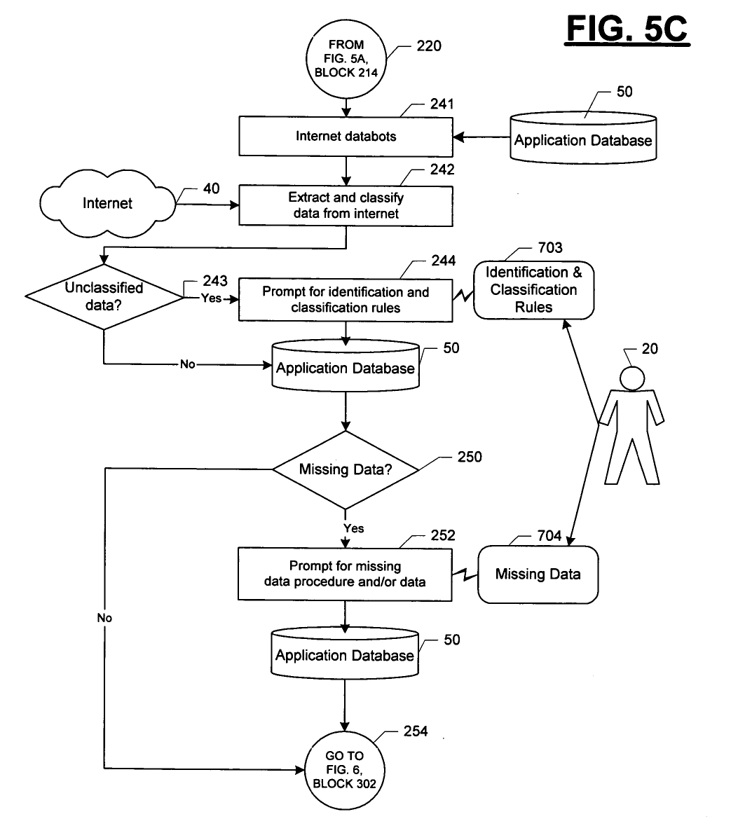

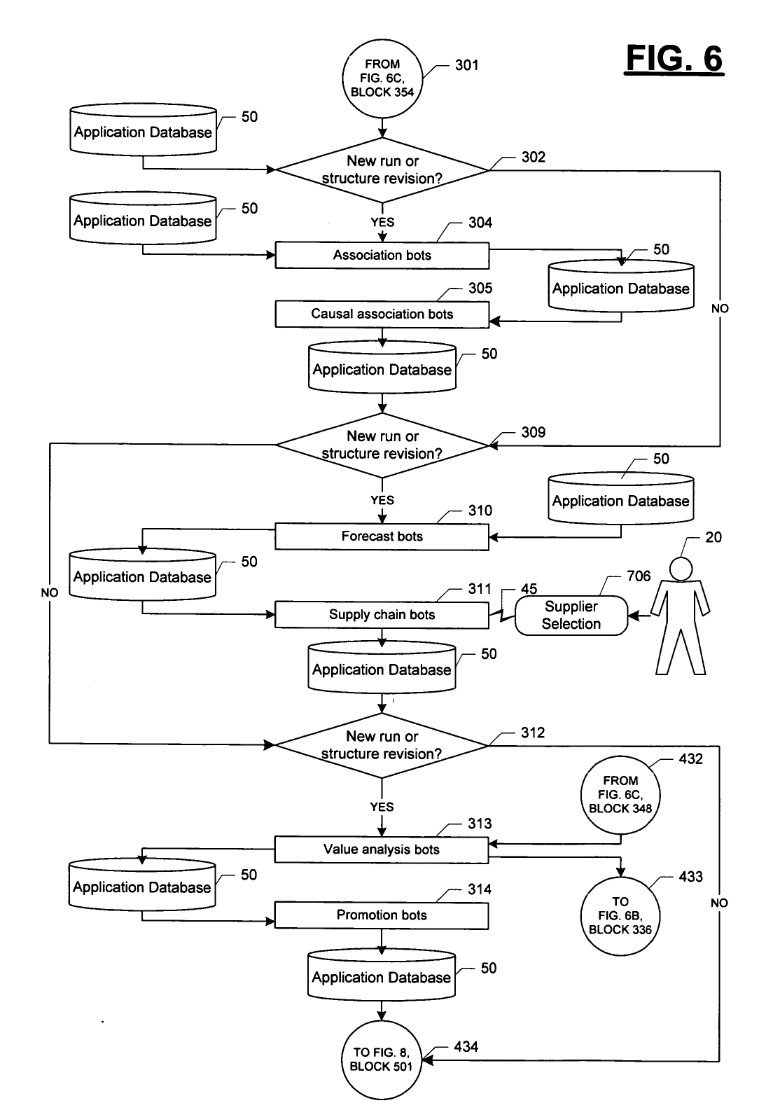

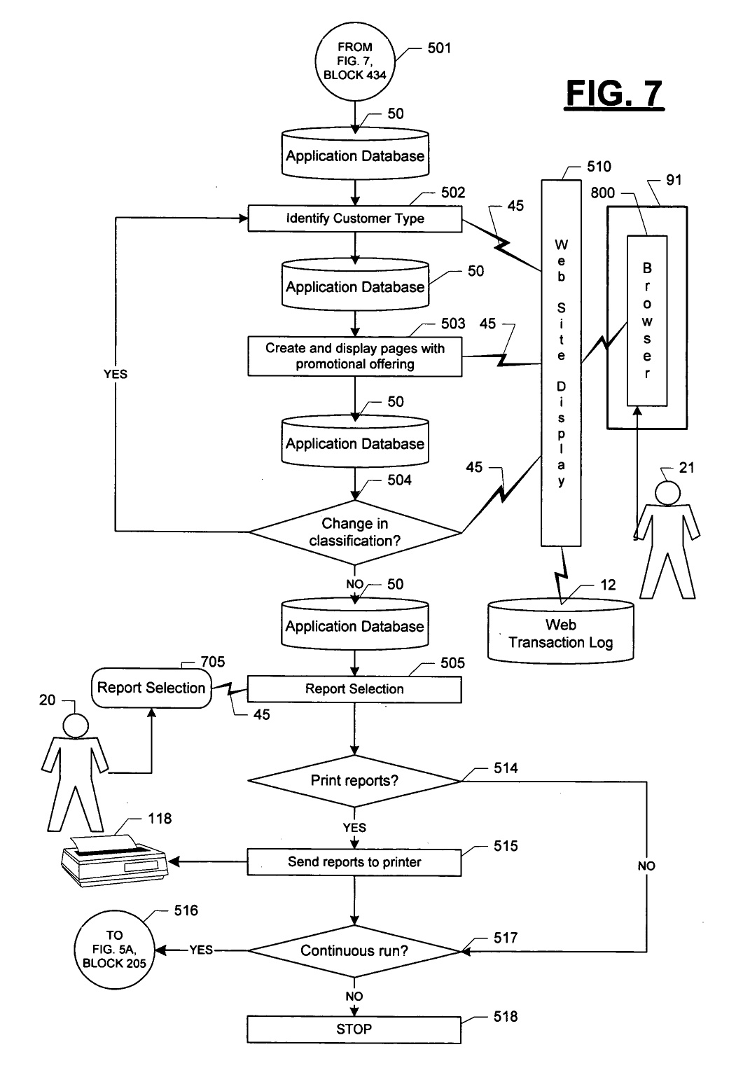

The activity analysis and promotion coordination using the approach outlined above is completed in three distinct stages. As shown in FIG. 5A, FIG. 5B and FIG. 5C, the first stage of processing (block 200 from FIG. 1) programs bots to continually extract, aggregate, manipulate and store the data from user input and databases and the internet (12, 15, 25, 35, 37 or 40) as required. Bots are independent components of the application that have specific tasks to perform. The second stage of processing (block 300 from FIG. 1) analyzes the supply chain status, volume purchase status, supplier value and customer value information as required to develop promotional offerings that enhance value by customer type. The third and final stage of processing (block 400 from FIG. 1) displays the value-building promotion information on a web site where the customer (21), using an access device (91) with browser software (800), reviews potential purchases and places orders (in a call center application the system would provide the information to the tele-sales representative).

### System Settings and Data Bots

The flow diagrams in FIG. 5A, FIG. 5B and FIG. 5C detail the processing that is completed by the portion of the application software (200) that extracts, aggregates, transforms and stores the information required for system operation from the: web site transaction database (12), enterprise performance management system database (15), organization performance management system database (25), customer relationship management system database (35), supply chain system database (37), the internet (40) and the user (20). A brief overview of the different databases will be presented before reviewing each step of processing completed by this portion (200) of the application software.

Cross referenced application Ser. No. 09/940,450 provides a detailed discussion of the database associated with performance management systems so we will start our discussion with web site transaction systems. Web site transaction log databases keep a detailed record of every visit to a web site; they can be used to trace the path of each visitor to the web site and upon further analysis can be used to identify patterns that are most likely to result in purchases and those that are most likely to result in abandonment. If the customer (21) has previously visited the site and/or has been tagged by one of the web marketing vendors such as Avenue A or Double Click, the customer's browser appliance (91) may contain one or more “cookies” that identify the customer in sufficient detail to categorize him or her when they first connect with a web site. This information can be used to develop a personalized greeting, such as “Welcome Back Tom!” This information can also be used to identify which promotion would generate the most value for the company using the system. Web site transaction logs generally contain the information shown in Table 1.

TABLE 1
Web Site Transaction Log Database

```
  1. Customer's URL
  2. Date and time of visit
  3. Pages visited
  4. Length of page visit (time)
  5. Type of browser used
  6. Referring site
  7. URL of site visited next
  8. Downloaded file volume and type
  9. Cookies
10. Transactions
```

While advanced financial planning systems have been around for some time, customer relationship management systems are a relatively recent development. Their appearance is further proof of the increasing importance of “soft” assets. Customer relationship management systems are similar to operation management systems in that they generally have the ability to forecast future events as well as track historical occurrences. Customer relationship management systems are well established at this point. In firms that sell customized products, the customer relationship management system is generally integrated with an estimating system that tracks the flow of estimates into quotations, orders and eventually bills of lading and invoices. In other firms that sell more standardized products, customer relationship management systems generally are used to track the sales process from lead generation to lead qualification to sales call to proposal to acceptance (or rejection) and delivery. All customer relationship management systems would be expected to track all of the customer's interactions with the enterprise after the first sale and store information similar to that shown below in Table 2.

TABLE 2
Customer Relationship Management System - Information

```
  1. Customer/Potential customer name
  2. Customer number
  3. Address
  4. Phone number
  5. Source of lead
  6. Date of first purchase
  7. Date of last purchase
  8. Last sales call/contact
  9. Sales call history
10. Sales contact history
11. Sales history: product/qty/price
12. Quotations: product/qty/price
13. Custom product percentage
14. Payment history
15. Current A/R balance
16. Average days to pay
```

Supply chain management system databases (37) contain information that may have been in performance management system databases (10) in the past. These systems provide enhanced visibility into the availability of goods and promote improved coordination between customers and their suppliers. All supply chain management systems would be expected to track all of the items ordered by the enterprise after the first purchase and store information similar to that shown below in Table 3.

TABLE 3
Supply Chain System Information

```
  1. Stock keeping unit
  2. Vendor
  3. Total quantity on order
  4. Total quantity in transit
  5. Total quantity on back order
  6. Total quantity in inventory
  7. Quantity available today
  8. Quantity available next 7 days
  9. Quantity available next 30 days
10. Quantity available next 90 days
11. Quoted lead time
12. Actual average lead time
```

System processing of the information from the different databases (5, 10, 12, 15, 25, 30, 35 and 37) and the internet (40) described above starts in a block 201, FIG. 5A, which immediately passes processing to a software block 202. The software in block 202 prompts the user (20) via the system settings data window (701) to provide system setting information. The system setting information entered by the user (20) is transmitted via the network (45) back to the application server (120) where it is stored in the system settings table (140) in the application database (50) in a manner that is well known. The specific inputs the user (20) is asked to provide at this point in processing are shown in Table 4.

```
TABLE 4
  1. New run or structure revision?
  2. Continuous, if yes, frequency? (hourly, daily, weekly,
  monthly or quarterly)
  3. Base account structure
  4. Metadata standard (XML, MS OIM, MDC)
  5. Location of enterprise or organization performance system
  database and metadata
  6. Location of web transaction database and metadata
  7. Location of customer relationship management system
  8. Location of supply chain management system database and metadata
  9. Location of account structure
10. Base currency
11. Location of database and metadata for equity information
12. Location of database and metadata for debt information
13. Location of database and metadata for tax rate information
14. Location of database and metadata for currency conversion
  rate information
15. Total cost of capital (weighted average cost of equity, debt
  and risk capital)
16. Number of months a product is considered new after it is first
  produced
17. Management report types (text, graphic, both)
18. Default reports
19. Default missing data procedure
20. Maximum time to wait for user input
21. Maximum discount rate for new projects (real option valuation)
22. Generic promotions (coupons, rebates, etc.)
23. Maximum number of sub-elements
24. Maximum number of customer segments
```

The enterprise checklists are used by a “rules” engine in block 202 to influence the number and type of items with pre-defined metadata mapping for each category of value. For example, if the checklists indicate that the enterprise is focused on branded, consumer markets, then additional brand related factors will be pre-defined for mapping. The application of these system settings will be further explained as part of the detailed explanation of the system operation.

The software in block 202 can use the current system date to determine the time periods (months) that require data in order to complete the current operation and the real option valuations and stores the resulting date range in the system settings table (140). In one embodiment the system utilizes data for the three year period before and the three year forecast period after the current date. The user (20) also has the option of specifying the data periods that will be used for completing system calculations.

After the storage of system setting data is complete, processing advances to a software block 203. The software in block 203 prompts the user (20) via the metadata and conversion rules window (702) to map metadata using the standard specified by the user (20) (XML, Microsoft Open Information Model of the Metadata Coalitions specification) from the web site transaction database (12), the enterprise performance management system database (15), the organization performance management system database (25), the customer relationship management system database (35) and the supply chain system database (37) to the enterprise hierarchy stored in the system settings table (140) and to the pre-specified fields in the metadata mapping table (141). Because the bulk of the information being extracted is financial information, the metadata mapping often takes the form of specifying the account number ranges that correspond to the different fields in the metadata mapping table (141). Table 5 shows the base account number structure that the account numbers in the other systems must align with. For example, using the structure shown below, the revenue component for the enterprise could be specified as enterprise 01, any department number, accounts 400 to 499 (the revenue account range) with any sub-account.

TABLE 5

| Account | | | | |
|---|---|---|---|---|
| Number | 01- | 902 (any)- | 477- | 86 (any) |
| Segment | Enterprise | Department | Account | Sub-account |
| Subgroup | Workstation | Marketing | Revenue | Singapore |
| Position | 4 | 3 | 2 | 1 |

As part of the metadata mapping process, any database fields that are not mapped to pre-specified fields are defined by the user (20) as component of value, elements of value or non-relevant attributes and “mapped” in the metadata mapping table (141) to the corresponding fields in each database in a manner identical to that described above for the pre-specified fields. After all fields have been mapped to the metadata mapping table (141), the software in block 203 prompts the user (20) via the metadata and conversion rules window (702) to provide conversion rules for each metadata field for each data source. Conversion rules will include information regarding currency conversions and conversion for units of measure that may be required to accurately and consistently analyze the data. The inputs from the user (20) regarding conversion rules are stored in the conversion rules table (142) in the application database. When conversion rules have been stored for all fields from every data source, then processing advances to a software block 204.

The software in block 204 checks the system settings table (140) in the application database (50) to determine if the current calculation is a new calculation or a structure change. If the calculation is not a new calculation or a structure change then processing advances to a software block 212. Alternatively, if the calculation is new or a structure change, then processing advances to a software block 207.

The software in block 207 checks the bot date table (148) and deactivates any web site transaction data bots with creation dates before the current system date and retrieves information from the system settings table (140), metadata mapping table (141) and conversion rules table (142). The software in block 207 then initializes data bots for each field in the metadata mapping table (141) that mapped to the web site transaction database (12) in accordance with the frequency specified by user (20) in the system settings table (140). Bots are independent components of the application that have specific tasks to perform. In the case of data acquisition bots, their tasks are to extract and convert data from a specified source and then store it in a specified location. Each data bot initialized by software block 207 will store its data in the web log data table (143). Every data acquisition bot for every data source contains the information shown in Table 6.

TABLE 6
1. Unique ID number (based on data, hour, minute, second of creation)
2. The data source location
3. Mapping information
4. Timing of extraction
5. Conversion rules (if any)
6. Storage location (to allow for tracking of source and destination events)
7. Creation date (date, hour, minute, second)
8. Enterprise or Organization

After the software in block 207 initializes all the bots for the web site transaction database, processing advances to a block 208. In block 208, the bots extract and convert data in accordance with their preprogrammed instructions in accordance with the frequency specified by user (20) in the system settings table (140). As each bot extracts and converts data from the web site transaction database (12), processing advances to a software block 209 before the bot completes data storage. The software in block 209 checks the web site transaction system metadata to see if all fields have been extracted. If the software in block 209 finds no unmapped data fields, then the extracted, converted data is stored in the basic financial system table (143). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the web log data table (143). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing passes on to software block 212.

The software in block 212 checks the system settings table (140) in the application database (50) to determine if the current calculation is a new calculation or a structure change. If the calculation is not a new calculation or a structure change then processing advances to a software block 228. Alternatively, if the calculation is new or a structure change, then processing advances to a software block 221.

The software in block 221 checks the bot date table (148) and deactivates any performance management system data bots with creation dates before the current system date and retrieves information from the system settings table (140), metadata mapping table (141) and conversion rules table (142). The software in block 221 then initializes data bots for each field in the metadata mapping table (141) that mapped to the performance management system database (15 or 25) in accordance with the frequency specified by user (20) in the system settings table (140). Each data bot initialized by software block 221 will store its data in the performance system data table (144).

After the software in block 221 initializes all the bots for the performance management system database (15 or 25), processing advances to a block 222. In block 222, the bots extract and convert data in accordance with their preprogrammed instructions with the frequency specified by user (20) in the system settings table (140). As each bot extracts and converts data from the performance management system database (15 or 25), processing advances to a software block 209 before the bot completes data storage. The software in block 209 checks the performance management system metadata to see if all fields have been extracted. If the software in block 209 finds no unmapped data fields, then the extracted, converted data is stored in the performance system table (144). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the performance system table (144). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 225.

The software in block 225 checks the bot date table (148) and deactivates any customer relationship management system data bots with creation dates before the current system date and retrieves information from the system settings table (140), metadata mapping table (141) and conversion rules table (142). The software in block 225 then initializes data bots for each field in the metadata mapping table (141) that mapped to the customer relationship management system database (12) in accordance with the frequency specified by user (20) in the system settings table (140). Each data bot initialized by software block 225 will store its data in the web log data table (172).

After the software in block 225 initializes all the bots for the customer relationship management system database (35), the bots extract and convert data in accordance with their preprogrammed instructions in accordance with the frequency specified by user (20) in the system settings table (140). As each bot extracts and converts data from the customer relationship management system database (35), processing advances to a software block 209 before the bot completes data storage. The software in block 209 checks the customer relationship management system metadata to see if all fields have been extracted. If the software in block 209 finds no unmapped data fields, then the extracted, converted data is stored in the web log data table (172). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the customer relationship management system data table (149). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to a software block 226.

The software in block 226 checks the bot date table (148) and deactivates any supply chain system data bots with creation dates before the current system date and retrieves information from the system settings table (140), metadata mapping table (141) and conversion rules table (142). The software in block 226 then initializes data bots for each field in the metadata mapping table (141) that mapped to the supply chain system database (37) in accordance with the frequency specified by user (20) in the system settings table (140). Each data bot initialized by software block 226 will store its data in the human resource system table (145).

After the software in block 226 initializes all the bots for the supply chain system database, the bots extract and convert data in accordance with their preprogrammed instructions in accordance with the frequency specified by user (20) in the system settings table (140). As each bot extracts and converts data from the supply chain system database (37), processing advances to a software block 209 before the bot completes data storage. The software in block 209 checks the supply chain system metadata to see if all fields have been extracted. If the software in block 209 finds no unmapped data fields, then the extracted, converted data is stored in the human resource system table (145). Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data is stored in the human resource system table (145). It is worth noting at this point that the activation and operation of bots that don't have unmapped fields continues. Only bots with unmapped fields “wait” for user input before completing data storage. The new metadata and conversion rule information will be used the next time bots are initialized in accordance with the frequency established by the user (20). In either event, system processing then passes on to software block 228.

The software in block 228 checks the system settings table (140) in the application database (50) to determine if the current calculation is a new calculation or a structure change. If the calculation is not a new calculation or a structure change then processing advances to a software block 248. Alternatively, if the calculation is new or a structure change, then processing advances to a software block 241.

The software in block 241 checks the bot date table (148) and deactivates any internet text and linkage bots with creation dates before the current system date and retrieves information from the system settings table (140), the metadata mapping table (141) and the keyword table (154). The software in block 241 then initializes internet text and linkage bots for each field in the metadata mapping table (141) that mapped to a keyword keyword matches and linkages from a specified source and then store their findings in a specified location. Each text and linkage bot initialized by software block 241 will store the location, count and classification data it discovers in the classified text table (151). Multimedia data can be processed using bots with essentially the same specifications if software to translate and parse the multimedia content is included in each bot. Every internet text and linkage bot contains the information shown in Table 7.

TABLE 7

| | |
|---|---|
| 1. | Unique ID number (based on date, hour, minute, second of |
| | creation) |
| 2. | Creation date (date, hour, minute, second) |
| 3. | Storage location |
| 4. | Mapping information |
| 5. | Home URL |
| 6. | Keyword |
| 7. | Enterprise or Organization |
| 8. | Descriptive term 1 |
| To | |
| 8 + n. | Descriptive term n |

In block 242 the text and linkage bots locate and classify data from the internet (40) in accordance with their programmed instructions in accordance with the frequency specified by user (20) in the system settings table (140). As each text and linkage bot locates and classifies data from the internet (40) processing advances to a software block 268 before the bot completes data storage. The software in block 243 checks to see if all linkages are identified and all keyword hits are associated with descriptive terms that have been been classified. If the software in block 243 doesn't find any unclassified “hits” or “links”, then the address, counts and classified text are stored in the classified text table (151). Alternatively, if there are terms that haven't been classified or links that haven't been identified, then processing advances to a block 244. The software in block 244 prompts the user (20) via the identification and classification rules window (703) to provide classification rules for each new term. The information regarding the new classification rules is stored in the keyword table (150) while the newly classified text and linkages are stored in the classified text table (151). It is worth noting at this point that the activation and operation of bots that don't have unclassified fields continues. Only bots with unclassified fields will “wait” for user input before completing data storage. The new classification rules will be used the next time bots are initialized in accordance with the frequency established by the user (20). In either event, system processing then passes on to a software block 250.

The software in block 270 checks: the web log data table (143), the performance system data table (144), the supply chain system table (145) and the customer relationship management system data table (149) to see if data are missing from any of the periods required for system calculation. The range of required dates was previously calculated by the software in block 202. If there are no data missing from any period, then processing advances to a software block 302. Alternatively, if there are missing data for any field for any period, then processing advances to a block 272.

The software in block 252 prompts the user (20) via the missing data window (704) to specify the method to be used for filling the blanks for each item that is missing data. Options the user (20) can choose for filling the blanks include: the average value for the item over the entire time period, the average value for the item over a specified period, zero, the average of the preceding item and the following item values and direct user input for each missing item. If the user (20) doesn't provide input within a specified interval, then the default missing data procedure specified in the system settings table (140) is used. When all the blanks have been filled and stored for all of the missing data, system processing advances to a block 302 where the promotion development process is started.

### Promotion Development Bots

The flow diagram in FIG. 7 details the processing that is completed by the portion of the application software (300) that analyzes and develops the value-building promotions for the different types of customers identified by the analysis bots in the previous stage of processing. The system of the present invention can also develop value-building promotions without segmenting the customers by setting the maximum number of customer segments in the system settings table (140) to one. However, in one embodiment, the promotions are segmented by customer type.

System processing in this portion of the application software (300) begins in a block 302. The software in block 302 checks the system settings table (140) in the application database (50) to determine if the current calculation is a new calculation or a structure change. If the calculation is not a new calculation or a structure change, then processing advances to a software block 309. Alternatively, if the calculation is new or a structure change, then processing advances to a software block 304.

The software in block 304 checks the bot date table (148) and deactivates any association bots with creation dates before the current system date. The software in block 304 then retrieves the information from the system settings table (140), the performance system table (144) and the SKU table (150) as required to initialize association bots for each customer group.

Bots are independent components of the application that have specific tasks to perform. In the case of association bots, their primary task is to identify baskets or clusters (hereinafter, baskets) of products or services purchased by each of the different customer groups identified by the analysis bots in the previous stage of processing. The association bots assign a unique id number to each “basket” it identifies and stores the unique id numbers in the cluster id table (154). The cluster id for each basket is also saved in the data record for each SKU in the SKU table (150). The baskets are identified by the apriori algorithm. Other association or market basket algorithms may be used to the same effect. Every association bot contains the information shown in Table 8.

TABLE 8
1. Unique ID number (based on date, hour, minute, second of creation)
2. Creation date (date, hour, minute, second)
3. Mapping information
4. Storage location
5. Customer group
6. Enterprise or Organization
7. Sensitivity factor

When bots in block 304 have identified and stored cluster id's for all the baskets identified for all the customer groups, processing advances to a software block 305.

The software in block 305 checks the bot date table (148) and deactivates any causal association bots with creation dates before the current system date. The software in block 305 then retrieves the information from the system settings table (140), the performance system table (144), the cluster id table (154) and the SKU table (150) as required to initialize causal association bots for each basket in accordance with the frequency specified by the user (20) in the system settings table (140).

Bots are independent components of the application that have specific tasks to perform. In the case of causal association bots, their primary task is to identify the SKUs that are causal factors in basket purchase decisions. The causal association bot uses the CCU algorithm to identify the causal items in each basket. Other causal association algorithms such as LCD can be used to the same effect. Every causal association bot activated in this block contains the information shown in Table 9.

TABLE 9
1. Unique ID number (based on date, hour, minute, second of creation)
2. Creation date (date, hour, minute, second)
3. Mapping information
4. Storage location
5. Cluster ID

After the causal association bots are initialized they activate in accordance with the frequency specified by the user (20) in the system settings table (140). Once activated, they retrieve the required information from the performance system table (144), the cluster id table (154) and the SKU table (150) and determine the causal items for each basket. The bot saves the causal item information in the SKU table (150) in the application database (50) and processing advances to block 309.

The software in block 309 checks the system settings table (140) in the application database (50) to determine if the current calculation is a new calculation or a structure change. If the calculation is not a new calculation or a structure change, then processing advances to a software block 312. Alternatively, if the calculation is new or a structure change, then processing advances to a software block 310.

The software in block 310 checks the bot date table (148) and deactivates any forecast bots with creation dates before the current system date. The software in block 310 then retrieves the information from the system settings table (140), the performance system table (144), the SKU table (150) and the SKU Life table (151) as required to initialize forecast bots for the causal SKUs identified by the bots in block 305 and their vendors in accordance with the frequency specified by the user (20) in the system settings table (140).

Bots are independent components of the application that have specific tasks to perform. In the case of forecast bots, their primary task is to update forecasts for the causal SKUs and their vendors. The forecast bots check the SKU life table for any impending obsolescence and use a variety of forecast methods as described in the related U.S. Pat. No. 5,615,109 a “Method of and System for Generating Feasible, Profit Maximizing Requisition Sets” to forecast demand for the causal SKUs and their vendors. Every forecast bot activated in this block contains the information shown in Table 10.

TABLE 10
1. Unique ID number (based on date, hour, minute, second of creation)
2. Creation date (date, hour, minute, second)
3. Mapping information
4. Storage location
5. SKU or Vendor
6. Enterprise or Organization

After the forecast bots are initialized they activate in accordance with the frequency specified by the user (20) in the system settings table (140). Once activated, they retrieve the required information and select the best fit forecast in accordance with the procedure described in the related U.S. Pat. No. 5,615,109 a “Method of and System for Generating Feasible, Profit Maximizing Requisition Sets”. After the forecast bots complete their calculations for each causal item and for the vendors of causal items, the bots save the updated forecasts in the performance system table (144) in the application database (50) and processing advances to a block 311.

The software in block 311 checks the bot date table (148) and deactivates any supply chain bots with creation dates before the current system date. The software in block 311 then retrieves the information from the system settings table (140), the performance system table (144), the SKU table (150) and the supply chain system table (145) as required to initialize supply chain bots for the causal SKUs identified by the bots in block 305 and their vendors in accordance with the frequency specified by the user (20) in the system settings table (140).

Bots are independent components of the application that have specific tasks to perform. In the case of supply chain bots, their primary task is to rank the vendors for each causal SKU on the basis of their ability to provide items in the required timeframe. The supply chain bots also forecast the net price per unit after all volume discounts are accounted for in accordance with the procedure described in the related U.S. Pat. No. 5,615,109 a “Method of and System for Generating Feasible, Profit Maximizing Requisition Sets”. Every supply chain bot contains the information shown in Table 11.

TABLE 11
1. Unique ID number (based on date, hour, minute, second of creation)
2. Creation date (date, hour, minute, second)
3. Mapping information
4. Storage location
5. SKU
6. Vendors

After the supply chain bots are initialized they activate in accordance with the frequency specified by the user (20) in the system settings table (140). Once activated, they retrieve the required information and rank the vendors for each causal SKU on the basis of item availability and forecast the net price to the company after volume discounts are considered in a manner similar to that described in the related U.S. Pat. No. 5,615,109 a “Method of and System for Generating Feasible, Profit Maximizing Requisition Sets”. After the supply chain bots rank the vendors for each causal item, the bots save the updated supplier rankings in the supplier ranking table (175) in the application database (50). The calculated rankings and any causal items that have insufficient supply are displayed to the user (20) using the supplier selection and warning window (706) for inspection before processing advances to software block 312.

The software in block 312 checks the system settings table (140) in the application database (50) to determine if the current calculation is a new calculation or a structure change. If the calculation is not a new calculation or a structure change, then processing advances to a software block 502. Alternatively, if the calculation is new or a structure change, then processing advances to a software block 313.

The software in block 313 checks the bot date table (148) and deactivates any value analysis bots with creation dates before the current system date. The software in block 313 then retrieves the information from the system settings table (140), the performance system table (144), the SKU table (150) and the supplier ranking table (146) as required to initialize value analysis bots in accordance with the frequency specified by the user (20) in the system settings table (140).

Bots are independent components of the application that have specific tasks to perform. In the case of value analysis bots, their primary task is to generate and forecast the value impact of promotional offerings for the causal SKUs and for the generic promotional offerings the user (20) specified in the system settings table (140) by customer group. The value analysis bots also examine the impact of generic promotions on customers that can't be classified during the web site visit. The analysis of promotional offerings considers the likelihood of acceptance based on history for customers in each segment (note: a segment can contain only one individual), the expected impact on purchase patterns and the expected impact on customer retention. Every value analysis bot contains the information shown in Table 12.

TABLE 12
1. Unique ID number (based on date, hour, minute, second of creation)
2. Creation date (date, hour, minute, second)
3. Mapping information
4. Storage location
5. Customer group
6. Causal SKU or Promotion

After the value analysis bots are initialized by the software in block 313 they activate in accordance with the frequency specified by the user (20) in the system settings table (140). After being activated, the bots retrieve information as required to revise the forecasts of element and component of value performance and updating the calculations completed in the prior stage of processing to forecast the value impact of the proposed promotions. The resulting forecast of value impacts are then saved in the SKU table (150) in the application database (50) and the bots created for the value analysis in prior stages of processing are deactivated before processing advances to a block 314.

The software in block 314 checks the bot date table (148) and deactivates any promotion bots with creation dates before the current system date. The software in block 314 then retrieves the information from the system settings table (140), the SKU table (150) and the promotions table (147) as required to initialize promotion bots in accordance with the frequency specified by the user (20) in the system settings table (140).

Bots are independent components of the application that have specific tasks to perform. In the case of promotion bots, their primary task is to rank the promotions by customer type on the basis of forecast value impact for all causal items where there is sufficient stock in inventory and the supply chain to meet forecast demand and for the generic promotions the user (20) specified in the system settings table (140). Every promotion bot contains the information shown in Table 13.

TABLE 13
1. Unique ID number (based on date, hour, minute, second of creation)
2. Creation date (date, hour, minute, second)
3. Mapping information
4. Storage location
5. Causal SKU

After the promotion bots are initialized by the software in block 314 they activate in accordance with the frequency specified by the User (20) in the system settings table (140). After being activated, the bots retrieve information as required to complete the ranking by value impact. The resulting ranking of promotional offerings for causal SKUs are then saved in the promotions table (147) in the application database (50) before processing advances to a software block 402.

### Output

The flow diagram in FIG. 8 details the processing that is completed by the portion of the application software (400) that generates and displays a web site containing the value-building promotional offerings developed in the prior stages of processing. Processing in this portion of the application starts in software block 402.

The software in block 402 receives company or third party “cookies” via a network (45) from the web site display software (410). The web site display software (410) can be any of a number of web site publishing packages such a Visual Interdev that integrate with back end databases and have the ability to generate web pages “on the fly” for unique visitors. The web site display software (410) obtains the “cookie” information in a manner that is well known when the browser software (800) in the customer's internet appliance (91) connects with the web site display software (410) via a network (45). The software in block 402 checks the performance system data table (144) and the web log data table (143) as required to identify the sub-element of customer value that the customer (21) fits into. If no classification can be made, then the customer id is “unknown”. After storing this information in the web log data table (143), processing advances to a block 403.

The software in block 403 checks the promotions table (147) to identify the appropriate promotion for the customer (21) and passes that information to the web site display software (410). The web site display software (410) in turn generates a new page displaying the appropriate promotion for the customer (21) in a manner that is well known. After the promotion information is transmitted, processing advances to a software block 404.

The software in block 404 monitors the activity for each customer (21) connected to the web site display (410) to see if they provide information (for example by filling out a survey or providing shipping information) that might change the classification that was made by the software in block 402. If a potential change is detected, then processing returns to block 402 where the customer may be reclassified and the processing described in the preceding paragraphs repeats itself. Alternatively, if no potential change is detected, then processing advances to a block 405.

The software in block 405 displays the report selection window (705) to the user (20). The user selects reports for printing. If the user (20) selects any reports for printing, then the information regarding the reports selected is saved in the reports table (152). After the user (20) has finished selecting reports, processing advances to a software block 414.

The software in block 414 checks the reports tables (152) to determine if any reports have been designated for printing. If reports have been designated for printing, then processing advances to a block 415. The software in block 415 sends the designated reports to the printer (118). After the reports have been sent to the printer (118), processing advances to a software block 417. Alternatively, if no reports were designated for printing then processing advances directly from block 414 to block 417.

The software in block 417 checks the system settings table (140) to determine if the system is operating in a continuous run mode. If the system is operating in a continuous run mode, then processing returns to block 205 and the processing described previously is repeated. Alternatively, if the system is not running in continuous mode, then the processing advances to a block 418 where the system stops.

Thus, the reader will see that the system and method described above transforms extracted transaction data, corporate information and information from the internet into a system to monitor and manage the customer acquisition and retention process.

While the above description contains many specificity's, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A computer supported sales method, comprising:
creating a model that quantifies a net impact of one or more elements and sub-elements of value on a value of a business with at least one sub-element of customer value by learning from the data,
defining one or more baskets purchased from the business and their associated causal SKU's by sub-element of customer value, and
identify a causal SKU promotional offer for each basket that maximizes business value using said model.

2. The method of claim 1 that further comprises:
obtaining information that identifies a sub-element of customer value for a potential customer,
presenting the value maximizing promotional offer for said sub-element of customer value to the customer using an interactive sales process, and
optionally, completing one or more sales transactions in an automated fashion.

3. The method of claim 1 where the net impacts are quantified for each of one or more categories of value where the categories of value are selected from the group consisting of current operation, real options, market sentiment and combinations thereof.

4. The method of claim 1 where the net impact of one or more elements and sub-elements of value is the direct impact of the element and sub-element on business value net of any impact on any other elements or sub-elements of value.

5. The method of claim 1 wherein supply chain status and forecast SKU availability are considered when selecting the promotional offer.

6. The method of claim 1 wherein the apriori algorithm is used to determine the content of the baskets typically purchased by each customer sub element of value.

7. The method of claim 1 wherein a CCU or LCD causal association algorithm is used to identify one or more causal SKU's for each basket.

8. The method of claim 1 wherein the business is a single product, a group of products, a division, a company, a multi company corporation or a value chain.

9. The method of claim 1 where the elements of value are from the group consisting of alliances, brands, channels, customers, customer relationships, employees, equipment, intellectual property, investors, partnerships, processes, production equipment, vendors, vendor relationships and combinations thereof.

10. The method of claim 1 wherein the interactive sales process is selected from the group consisting of e-commerce sales, sales from on-line exchanges, telemarketing and combinations thereof.

11. A computer readable medium having sequences of instructions stored therein, which when executed cause the processors in a plurality of computers that have been connected via a network to perform a pricing method, comprising:
obtaining a model that includes at least one sub element of customer value and identifies a net contribution of one or more elements and sub-elements of value to a value of a business by category of value;
defining one or more baskets purchased from the business and their associated causal SKU's by sub-element of customer value; and
identifying a causal SKU promotional offer for each basket that maximizes business value using said model.

12. The computer readable medium of claim 11 where the method further comprises:
obtaining information that identifies a sub-element of customer value for a potential customer;
presenting the value maximizing promotional offer for said sub-element of customer value to the customer using an interactive sales process; and
optionally, completing sales transactions in an automated fashion.

13. The computer readable medium of claim 11 where the contribution model is developed by learning from business related data.

14. The computer readable medium of claim 11 where the categories of value are selected from the group consisting of current operation, real options, market sentiment and combinations thereof.

15. The computer readable medium of claim 11 wherein supply chain status and forecast availability are considered when selecting the promotional offer.

16. The computer readable medium of claim 11 wherein the apriori algorithm is used to determine the content of the baskets typically purchased by each customer sub element of value.

17. The computer readable medium of claim 11 wherein a CCU or LCD causal association algorithm is used to identify one or more causal SKU's for each basket.

18. The computer readable medium of claim 11 wherein the business is a single product, a group of products, a division, a company, a multi company corporation or a value chain.

19. The computer readable medium of claim 11 where the elements of value are from the group consisting of alliances, brands, channels, customers, customer relationships, employees, equipment, intellectual property, investors, partnerships, processes, production equipment, vendors, vendor relationships and combinations thereof.

20. The computer readable medium of claim 11 wherein the interactive sales process is selected from the group consisting of e-commerce sales, sales from on-line exchanges, telemarketing and combinations thereof.

21. The computer readable medium of claim 11 where the net contribution of one or more elements and sub-elements of value is the direct contribution of the element and sub-element to business value net of any contribution to any other elements or sub-elements of value.

22. A computer readable medium having sequences of instructions stored therein, which when executed cause the processor in a computer to perform a process method, comprising:
obtaining a process specification,
creating a model that quantifies a net impact of one or more elements of value on a value of a business,
identifying one or more relationships between specified process outputs and the elements of value in said model, and
determining a set of process variable values that will optimize one or more aspects of business financial performance using said model and relationships.

23. The computer readable medium of claim 22 where the model is created by learning from business related data.

24. The computer readable medium of claim 22 where the model quantifies net element impacts by category of value where the categories of value are selected from the group consisting of current operation, real options, market sentiment and combinations thereof.

25. The computer readable medium of claim 22 where the aspects of financial performance are selected from the group consisting of revenue, expense, capital change, current operation value, real option value, market value and combinations thereof.

26. The computer readable medium of claim 22 wherein the process is an interactive sales process and the process variables include the promotional price for causal SKU's by basket and vendor order quantities.

27. The computer readable medium of claim 22 where optimizations are completed using methods from the group consisting of genetic algorithms, multi criteria optimization models and Monte Carlo simulations.

28. The computer readable medium of claim 22 where processes are selected from the group consisting of purchasing, replenishment, sales and combinations thereof.

29. The computer readable medium of claim 28 where the purchasing optimization includes an optimization of purchase volume discounts.

30. The computer readable medium of claim 22 where the process specification includes attributes from the group consisting of process budget, process operating factors, process outputs, process variables, the relationship between process variables, budget and outputs and combinations thereof.
